(19) United States
(12) Patent Application Publication
(10) Pub. No.: US 2021/0350260 A1
(43) Pub. Date: Nov. 11, 2021

(54) DECISION LIST LEARNING DEVICE, DECISION LIST LEARNING METHOD, AND DECISION LIST LEARNING PROGRAM

(71) Applicant: NEC Corporation, Minato-ku, Tokyo (JP)

(72) Inventors: Yuzuru OKAJIMA, Tokyo (JP); Kunihiko SADAMASA, Tokyo (JP)

(73) Assignee: NEC Corporation, Minato-ku, Tokyo (JP)

(21) Appl. No.: 17/277,520

(22) PCT Filed: Sep. 21, 2018
(86) PCT No.: PCT/JP2018/035162

§ 371 Date: Mar. 18, 2021

(51) Int. Cl. G06N 5/04; G06N 20/00

(52) U.S. Cl. CPC G06N 5/04; G06N 20/00

(57) ABSTRACT

The input unit 81 receives a set of rules each including a condition and a prediction, and pairs of observed data and correct answers. The stochastic decision list generator 82 assigns each rule in the set of rules to a plurality of positions in the decision list with a degree of occurrence indicating occurrence degree. The learning unit 83 updates a parameter determining the degree of occurrence so that a difference between an integrated prediction acquired by integrating, based on the degree of occurrence, the predictions of the rules whose conditions are satisfied by the observed data and the correct answer becomes small.

### TECHNICAL FIELD

This invention relates to a decision list learning device, a decision list learning method, and a decision list learning program for learning a decision list.

### BACKGROUND ART

In the field of machine learning, a rule-based model that combines several simple conditions has the advantage of being easy to interpret.

A decision list is one of the rule-based models. A decision list is an ordered list of rules including conditions and predictions. Given an example, the predictor goes through this list in order, adopts the first rule whose condition fits the example and outputs the prediction of that rule.

Non patent Literature 1 describes an example of a method for optimizing a decision list. In the method described in Non Patent 1, a Markov chain Monte Carlo method is used to optimize a decision list.

### CITATION LIST

### Non-Patent Literature

Non-patent Literature 1: Letham, Benjamin, Rudin, Cynthia, McCormick, Tyler H., and Madigan, David, “Interpretable classifiers using rules and Bayesian analysis: Building a better stroke prediction model”, Annals of Applied Statistics, 9(3), pp. 1350-1371, 2015.

### SUMMARY OF INVENTION

### Technical Problem

A decision list has the advantage of high interpretability, but the disadvantage is that they are difficult to optimize. If the model has continuous parameters, such as a linear model or a neural network, its optimization is a continuous optimization problem. Therefore, continuous optimization techniques can be easily applied, such as calculating the gradient by differentiation and using the gradient descent method. However, the optimization is a discrete optimization problem because the decision list does not have continuous parameters and the prediction is determined only by the order of application of the rules. Therefore, it is difficult to optimize the decision list because it cannot be differentiated by parameters.

The method described in non patent 1 is to randomly change the decision list until the prediction accuracy is improved, and it is necessary to try various lists over a long period of time until a preferred decision list is obtained by chance. Therefore, the method described in non patent reference 1 is inefficient because it takes a very long time to obtain a decision list with high prediction accuracy, and it is difficult to derive a decision list with high prediction accuracy in a realistic computational time.

Therefore, the present invention is intended to provide a decision list learning device, a decision list learning method, and a decision list learning program that can construct a decision list in a practical time while increasing prediction accuracy.

### Solution to Problem

A decision list learning device according to the present invention is a decision list learning device for learning a decision list, and includes an input unit which receives a set of rules each including a condition and a prediction, and pairs of observed data and correct answers, a stochastic decision list generator which assigns each rule in the set of rules to a plurality of positions in the decision list with a degree of occurrence indicating occurrence degree, and a learning unit which updates a parameter determining the degree of occurrence so that a difference between an integrated prediction acquired by integrating, based on the degree of occurrence, the predictions of the rules whose conditions are satisfied by the observed data and the correct answer becomes small.

A method for learning a decision list according to the present invention is a method for learning a decision list, and includes receiving a set of rules each including a condition and a prediction, and pairs of observed data and correct answers, assigning each rule in the set of rules to a plurality of positions in the decision list with a degree of occurrence indicating occurrence degree, and updating a parameter determining the degree of occurrence so that a difference between an integrated prediction acquired by integrating, based on the degree of occurrence, the predictions of the rules whose conditions are satisfied by the observed data and the correct answer becomes small.

A decision list learning program according to the present invention is a decision list learning program applied to a computer learning a decision list, and causes the computer to execute an inputting process of receiving a set of rules each including a condition and a prediction, and pairs of observed data and correct answers, a stochastic decision list generating process of assigning each rule in the set of rules to a plurality of positions in the decision list with a degree of occurrence indicating occurrence degree, and a learning process of updating a parameter determining the degree of occurrence so that a difference between an integrated prediction acquired by integrating, based on the degree of occurrence, the predictions of the rules whose conditions are satisfied by the observed data and the correct answer becomes small.

### Advantageous Effects of Invention

According to the present invention, a decision list can be constructed in a practical time while increasing prediction accuracy.

### BRIEF DESCRIPTION OF DRAWINGS

FIG. 1 It depicts a block diagram showing an example configuration of a first embodiment of a decision list learning device according to the present invention.

FIG. 2 It depicts an explanatory diagram showing an example of a rule set.

FIG. 3 It depicts an explanatory diagram showing an example of a stochastic decision list.

FIG. 4 It depicts an explanatory diagram of an example process for deriving a weighted linear combination.

FIG. 5 It depicts a flowchart showing an example of the process of calculating a predicted value.

FIG. 6 It depicts an explanatory diagram of an example of a learning result.

FIG. 7 It depicts an explanatory diagram of an example of the process of generating a decision list.

FIG. 8 It depicts a flowchart showing an example of operation of the decision list learning device of the first example embodiment.

FIG. 9 It depicts a block diagram showing a modified example of the decision list learning device of the first example embodiment.

FIG. 10 It depicts an explanatory diagram of an example of the process of extracting a rule.

FIG. 11 It depicts a block diagram showing an example configuration of a second example embodiment of a decision list learning device according to the present invention.

FIG. 12 It depicts an explanatory diagram showing an example of a stochastic decision list.

FIG. 13 It depicts a block diagram showing an example of an information processing system of the present invention.

FIG. 14 It depicts a block diagram showing a summarized decision list learning device according to the present invention.

FIG. 15 It depicts a summarized block diagram showing a configuration of a computer for at least one example embodiment.

### DESCRIPTION OF EMBODIMENTS

Hereinafter, example embodiments of the present invention will be described with reference to the drawings. In the present invention, it is considered that the problem of predicting the correct answer y with x as the observed data. In the following, we will describe a regression problem where y is an arbitrary continuous value, but it can also be applied to the classification problem by using the probability of belonging to a class as y.

### Example Embodiment 1

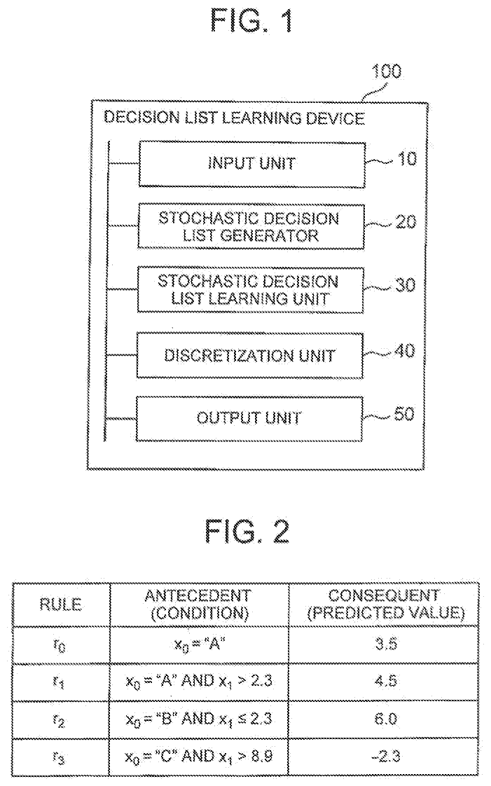

FIG. 1 is a block diagram showing an example configuration of a first example embodiment of a decision list learning device according to the present invention. The decision list learning device 100 in this example embodiment is a device for learning a decision list in which an order of application of a rule is determined based on its position on the list. The decision list learning device 100 has an input unit 10, a stochastic decision list generator 20, a stochastic decision list learning unit 30, a discretization unit 40, and an output unit 50.

The input unit 10 receives a rule set to be optimized. The rule set is a set of rules each of which includes a condition on observed data and a prediction when the observed data satisfies the condition. Each rule in the rule set may be indexed. In this case, each rule may be arranged in order according to the index. The input unit 10 also accepts a set of training data that is a pair of observed data and a correct answer.

In this example embodiment, it is assumed that the rule set is pre-built. Each rule is assigned an index starting with 0, and the rule identified by index j is denoted by rⱼ. Also, the prediction (predicted value) of this rule is denoted by y\hat{ }ⱼ, or yⱼ with superscript \hat{ }.

FIG. 2 is explanatory diagram showing an example of a rule set. In the example shown in FIG. 2, each rule includes a condition regarding observed data x=[x₀, x₁]^{T}. The rule used in this example embodiment can be, for example, a rule automatically acquired by applying frequent pattern mining to the training data or a rule manually created by a person.

Various conditions of the rule may be used on the condition true or false is determined when observed data is provided. The condition of the rule may include, for example, a composite condition in which multiple conditions are combined by AND. Also, a rule extracted by frequent pattern mining, such as a rule described in the non patent document 1, may be used. In addition, a rule extracted by a decision tree ensemble, such as Random Forest, may be used. The method of extracting a rule by decision tree ensemble is described below.

The stochastic decision list generator 20 generates a list that maps a rule to a degree of occurrence (occurrence degree) that indicates the degree to which the rule appears. The degree of occurrence is a value indicating the degree to which the rule appears at a particular position in the decision list. The stochastic decision list generator 20 of this example embodiment generates a list in which each rule included in the set of received rules is assigned to a plurality of positions on the decision list with a degree of occurrence indicating the degree of occurrence.

In the following description, the degree of occurrence will be treated as a probability that a rule will appear on the decision list (hereinafter referred to as the probability of occurrence). The list generated is hereinafter referred to as the stochastic decision list. The list generated is hereafter referred to as the stochastic decision list.

The way in which the stochastic decision list generator 20 assigns the rules to multiple positions on the decision list is arbitrary. However, in order to enable the stochastic decision list learning unit 30, which will be described below, to properly determine the order of the rules on the decision list, it is preferable to assign the rules to cover the before and after relationship of each rule. The stochastic decision list generator 20 is preferable, for example, when assigning a first rule and a second rule, the second rule is assigned after the first rule and then the first rule is assigned after the second rule. The number of rules assigned by the stochastic decision list generator 20 may be the same or different for each rule.

The stochastic decision list generator 20 may generate a stochastic decision list of length δ|R| by duplicating a list of length |R| in which all the rules in the rule set R is arranged according to the index, with quantity of δ, and concatenating duplicates. In this way, by generating a stochastic decision list by duplicating the same rule set, the learning process by the stochastic decision list learning unit 30, which will be described below, can be made more efficient.

In the case of the above example, the rule rⱼ appears a total of δ times in the list, and its position of occurrence is represented by Equation 1, which is illustrated below.

π(j,d)=d*|R|+j(d∈[0,δ−1|) (Equation 1)

The stochastic decision list generator 20 may calculate the probability p_{π(j,d)} of the rule rⱼ appearing at position π(j,d), as the degree of occurrence, using a soft-max function with temperature illustrated in Equation 2 below. In Equation 2, τ is a temperature parameter and w_{j,d} is a parameter representing degree to which the rule rⱼ appears at position π(j,d) in the list.

$$\begin{matrix}[ Math . 1 ] & \\ {p}_{π ( j , d )} = \frac{exp ( {w}_{j , d} / τ )}{{\sum }_{{d}^{′} = 0}^{δ} exp ( {w}_{j , {d}^{′}} / τ )} & ( Equation 2 )\end{matrix}$$

Thus, the stochastic decision list generator 20 may generate the stochastic decision list in which rules are assigned to multiple positions in the decision list, with a probability of occurrence defined by the soft-max function illustrated in Equation 2.

Here, in Equation 2, the parameter for d=δ (i.e., w_{j,d}) is a parameter that represents the degree to which rule rⱼ does not appear in the list. That is, the stochastic decision list generator 20 generates a rule set of candidates that can be included in the decision list (sometimes referred to as an in-list rule set) and a rule set of candidates that are not included in the decision list and a rule set of candidates that are not included in the decision list (sometimes referred to as an out-list rule set).

In Equation 2 above, the parameters w_{j,d} are any real number in the range [−∞,∞]. However, the probability p_{j,d} is normalized to a total of 1 by the soft-max function. That is, for each rule, the sum of the probability of occurrence at δ positions in the list and the probability of not appearing in the list is 1.

In Equation 2, as the temperature i approaches 0, the output of the soft-max function approaches the one-hot vector. That is, in a rule, a probability is 1 at only one position, and a probability is 0 at all other positions.

In the following description, the scope of determining a rule from the multiple rules assigned is referred to as a group. In this example embodiment, a group is defined as a collection of identical rules. Therefore, it can be said that the stochastic decision list generator 20 determines the degree of occurrence so that the sum of the degrees of occurrence of rules belonging to the same group is 1. In other words, the stochastic decision list generator 20 in this example embodiment determines the degree of occurrence so that a sum of the degrees of occurrence of the same rules assigned to a plurality of positions is 1.

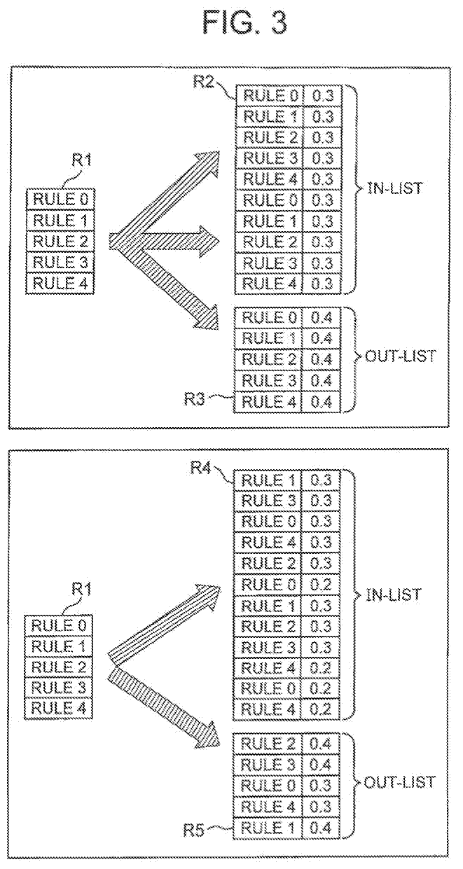

FIG. 3 illustrates an example of the process of generating a stochastic decision list. In the example shown in the upper in FIG. 3, suppose that the input unit 10 receives a rule set R1 including five rules and generates a stochastic decision list including three duplicated rule sets from the rule set R1 (δ=2). In this case, the first two rule sets correspond to the in-list rule set R2 and the remaining one rule set corresponds to the out-list rule set R3.

In the example shown in the upper in FIG. 3, the degree of occurrence of each rule in the in-list rule set R2 is set to 0.3 and the degree of occurrence of each rule in the out-list rule set R3 is set to 0.4. However, the set degree of occurrence does not have to be the same in the in-list rule set R2 and the out-list rule set R3, and any degree of occurrence can be set. Note that in this example embodiment, it is determined so that the sum of the degrees of occurrence of the rules belonging to the same group is 1.

For example, if a group including three rules 0 is focused on, the sum of the degrees of occurrence of rules 0, as illustrated in FIG. 3, is set to 0.3+0.3+0.4=1.0. The same is true for the other rules.

As shown in the lower in FIG. 3, the stochastic decision list generator 20 may generate a stochastic decision list (in-list rule set R4 and out-list rule set R5) by randomly selecting rules from the received rule set R1. However, as described above, a regular arrangement of rules is more preferable from the viewpoint of a computation (more specifically, from the viewpoint of a matrix computation).

The stochastic decision list learning unit 30 integrates predictions of rules for which the observed data in the received training data satisfies the condition, based on the degrees of occurrence corresponding to the rules. The predictions integrated are hereafter referred to as an integrated prediction. The stochastic decision list learning unit 30 then learns the stochastic decision list by updating the parameters determining the degree of occurrence so that a difference between the integrated prediction and the correct answer becomes small. In the example in Equation 2 above, the stochastic decision list learning unit 30 learns the stochastic decision list by updating the parameters w_{j,d}.

Specifically, first, the stochastic decision list learning unit 30 extracts the rules that include conditions satisfied by the received observed data. Next, the stochastic decision list learning unit 30 calculates the weights of the rules so that when the extracted rules are arranged in order, the greater the degree of occurrence of the rule whose condition is satisfied by the observed data, the less a weight of a following rule. The stochastic decision list learning unit 30 then integrates the predictions of the rules using the calculated weights, which are the integrated prediction.

For example, when the degree of occurrence of a rule is represented by probability p, the stochastic decision list learning unit 30 may calculate weights of the rules by multiplying the degree of occurrence of the subsequent rule by the cumulative product of (1−p), and define the weighted linear sum (weighted linear combination) that is a sum of multiplication results of multiplying the calculated weights by respective predictions as the integrated prediction. For example, if the stochastic decision list is generated with duplicates of the rule set R, the integrated prediction y\hat{ } is represented by Equation 3, which is illustrated below.

$$\begin{matrix}[ Math . 2 ] & \\ \hat{y} = ( {\sum }_{i = 0}^{δ \vert R \vert - 1} {i}_{} ( x ) {q}_{i} {p}_{i} {\hat{y}}_{λ ( i )} ) \\ {q}_{i} = {\prod }_{k = 0}^{i - 1} {k}_{} ( x ) ( 1 - {p}_{k} ) & ( Equation 3 )\end{matrix}$$

In Equation 3, λ(i)=i %|R| is an index indicating the rule corresponding to the position i. Also, lᵢ(x) is a function that is set to 1 if the condition of the rule corresponding to the position i satisfied by input x and 0 if it is not satisfied.

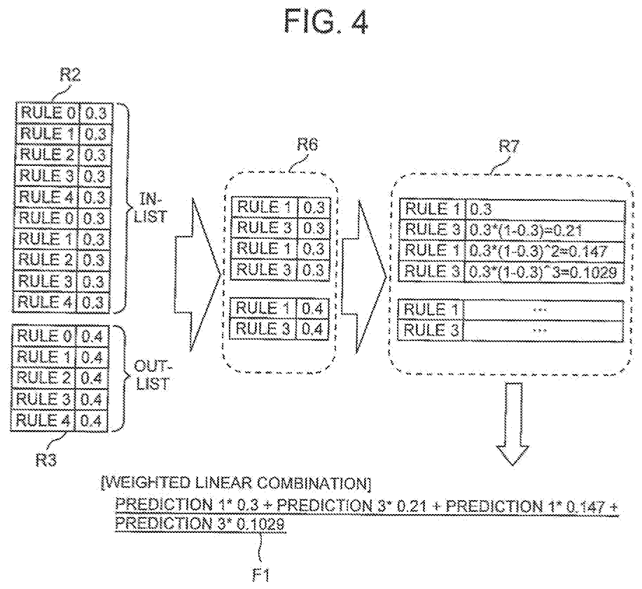

FIG. 4 illustrates an example of the process of deriving a weighted linear combination.

Suppose that in a situation where the stochastic decision list illustrated in FIG. 3 has been generated, observed data satisfying the conditions of rule 1 and rule 3 are received. In this case, the stochastic decision list learning unit 30 extracts the rules 1 and 3 that include the conditions satisfied by the received observed data (rule list R6).

Next, the stochastic decision list learning unit 30 calculates the weights by multiplying the probability p of each rule, in order from the top of the stochastic decision list, by the value of the probability p of the rule before it subtracted from 1 (i.e., 1−p). In the example shown in FIG. 4, if the probability of rule 1 at the first line is 0.3, the stochastic decision list learning unit 30 calculates the weight (0.21) of rule 3 at the second line by multiplying the probability of rule 3, i.e., 0.3, by the value of the probability of rule 1 at the first line, subtracted from 1 (i.e., 1−0.3).

Similarly, the stochastic decision list learning unit 30 calculates the weight (0.147) of rule 1 at the third line by multiplying the probability of rule 1, i.e., 0.3, by the value of the probability of rule 1 at the first line, subtracted from 1 (i.e., 1−0.3) and the value of the probability of rule 3 at the second line, subtracted from 1 (i.e., 1−0.3). The stochastic decision list learning unit 30 also calculates the weight of rule 3 at the fourth line by multiplying the probability of rule 3, i.e., 0.3, by the value of the probability of rule 1 at the first line, subtracted from 1 (i.e., 1−0.3), the value of the probability of rule 3 at the second line, subtracted from 1 (i.e., 1−0.3) and the value of the probability of rule 1 at the third line, subtracted from 1 (i.e., 1−0.3) (calculation result R7).

As mentioned above, the stochastic decision list learning unit 30 does not use the degrees of occurrence of rules included in the out-list rule set for calculating weights, because the out-list rule set is a set of candidate rules that are not included in the decision list.

The stochastic decision list learning unit 30 calculates the weighted linear combination using the calculated weights as coefficients of each prediction, as the predicted value. In the example shown in FIG. 4, the weighted linear combination F1 is calculated by multiplying the prediction 1 by rule 1 at the first line, the prediction 3 by rule 3 at the second line, the prediction 1 by rule 1 at the third line, and the prediction 3 by rule 3 at the fourth line by the weights, 0.3, 0.21, 0.147, and 0.1029, respectively, and adding multiplying results.

In consideration of the case where there is no rule including the conditions to be satisfied by the received observed data, a default predicted value may be provided. In this case, the integrated prediction y\hat{ } may be represented by Equation 4, which is illustrated below. In Equation 4, y\hat{ }_{def} is the default predicted value. For example, y\hat{ }_{def} may be the average value of all y in the training data.

$$\begin{matrix} [ Math . 3 ] & \\ \hat{y} = ( {\sum }_{i = 0}^{δ \vert R \vert - 1} {i}_{} ( x ) {q}_{i} {p}_{i} {\hat{y}}_{λ ( i )} ) + ( 1 - {\sum }_{i = 0}^{δ \vert R \vert - 1} {i}_{} ( x ) {q}_{i} {p}_{i} ) {\hat{y}}_{def} & ( Equation 4 )\end{matrix}$$

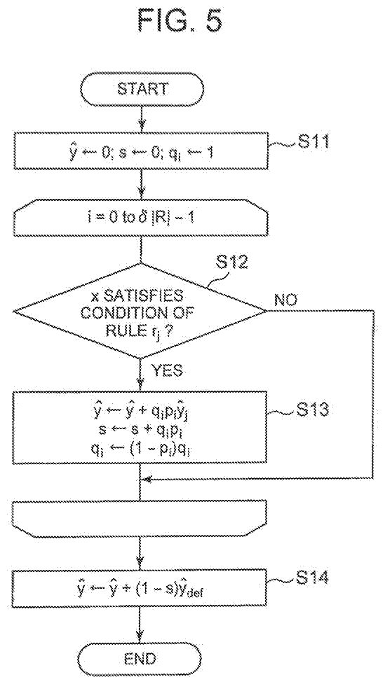

FIG. 5 is a flowchart showing an example of the process of calculating the predicted value y\hat{ }. The stochastic decision list learning unit 30 first sets 0 to y\hat{ } and s, respectively, as initial values, and sets 1 to qᵢ (step S11). Next, the stochastic decision list learning unit 30 repeats the process of steps S12 to S13 shown below, from i=0 to δ|R|−1.

When the input x satisfies the condition of the rule rⱼ (Yes in step S12), the stochastic decision list learning unit 30 adds qᵢpᵢy\hat{ }ⱼ to y\hat{ }, adds qᵢpᵢ to s, and multiplies qᵢ by (1−pᵢ) (step S13). On the other hand, when the input x does not satisfy the condition of the rule rⱼ (No in step S12), the process of step S13 is not performed. Then, the stochastic decision list learning unit 30 adds (1−s)y\hat{ }_{def} to the predicted value y\hat{ } (step S14), and the added value is set to the predicted value y\hat{ }.

As a result of the process illustrated in FIG. 5, rules that do not hit will be relegated to the lower levels, and rules that do hit will be learned to float in the upper levels. In addition, the algorithm illustrated in flowchart of FIG. 5 can be interpreted as follows. As shown in the above Equation 4, the predicted value y\hat{ } is the weighted average of the predicted values of all rules for which the input x satisfies the conditions and the default predicted values. Then, the probability pᵢ of the occurrence of the rule at a position i acts as a penalty for all predicted values of subsequent rules. That is, the higher the value of pᵢ, the lower the weights of the predicted values of the subsequent rules.

For example, when pᵢ=1, the weights of the predicted values of the subsequent rules are all zero. In particular, in the above Equation 2, when τ is as close to 0 as possible, each rule exists with probability 1 only at one of the positions. That is, at all positions i, pᵢ is either 0 or 1. In this case, the predicted value of the first rule in rules that have pᵢ=1 and whose input x satisfies the condition will be the final predicted value.

This means that the stochastic decision list converges to the general discrete decision list, where it is considered that only rules with pᵢ=1 exist. Thus, it can be said that the stochastic decision list as described above is similar to the usual discrete decision list.

In other words, an effect that following rules that exist after the rule do not have to be used is obtained, by calculation the weights of the rules by the stochastic decision list learning unit 30 so that the greater the degree of occurrence of a rule whose condition is satisfied by the observed data, the less the weigh of a rule that follows the rule. This can be said to derive the final decision list from the stochastic decision list which is considered to be stochastically distributed.

It is arbitrary how the stochastic decision list learning unit 30 updates the parameter to determine the degree of occurrence so that the difference between the integrated prediction and the correct answer becomes small. For example, using the training data D={(xᵢ,yᵢ)}ⁿ⁻¹ᵢ₌₀ which is a set of pairs of observed data xᵢ and the correct answer yᵢ, and a parameter W that determines the degree of occurrence, the loss function L(D; W), the error function E(D; W), and the regularization term R(W) may be defined as in Equation 5 which is illustrated below.

L(D;W)=E(D;W)+cR(W) (Equation 5)

c is a hyperparameter to balance the error function and the regularization term. For example, in the case of a regression problem, the mean square error illustrated in Equation 6 below may be used as the error function E(D; W). For example, in the case of a classification problem, cross entropy may be used as the error function. In other words, any error function may be defined as long as the slope can be calculated.

$$\begin{matrix}[ Math . 4 ] & \\ E ( D \text{;} W ) = \frac{1}{n} {\sum }_{i = 0}^{n - 1} {( {y}_{i} - {\hat{y}}_{i} )}^{2} & ( Equation 6 )\end{matrix}$$

As a regularization term R(W), for example, Equation 7 as shown below, may be used. The regularization term illustrated in Equation 7 is the sum of the probabilities of being in the list for all rules. The addition of this regularization term reduces the number of rules in the list and thus improves the generalization performance.

$$\begin{matrix}[ Math . 5 ] & \\ R ( W ) = {\sum }_{j = 0}^{\vert R \vert - 1} \frac{{\sum }_{d = 0}^{δ - 1} exp ( {w}_{j , d} / τ )}{{\sum }_{d = 0}^{δ} exp ( {w}_{j , d} / τ )} & ( Equation 7 )\end{matrix}$$

The stochastic decision list training unit 30 calculates the slope of the loss function and minimizes it using the gradient descent method. If a stochastic decision list is generated by duplicating one rule multiple times, in the above Equation 2, w_{j,d} can be defined as a matrix of size (|R|, δ+1) with the element in row j, column d. By defining the parameters in this way, it is possible to calculate the gradient by a matrix operation.

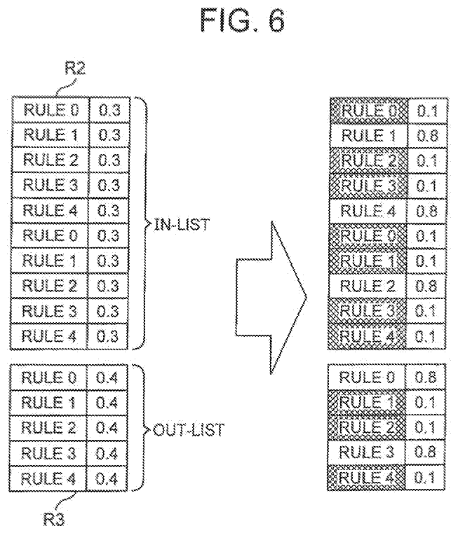

FIG. 6 is an explanatory diagram of an example of a learning result. For example, as a result of learning by the stochastic decision list learning unit 30 based on the stochastic decision list illustrated in FIG. 3, the degree of occurrence of each rule is optimized and updated to improve prediction accuracy. Specifically, in the example shown in FIG. 6, the degrees of occurrence of rule 1 at line 2, rule 4 at line 5, and rule 2 at line 8 are updated from 0.3 to 0.8, respectively, indicating that the degree of occurrence of the rule in the appropriate position has been improved. In the example shown in FIG. 6, the degrees of occurrence of rule 0 at line 1 and rule 0 at line 4 in the out-list rule set have been updated from 0.4 to 0.8, respectively, indicating the low applicability of these rules.

The discretization unit 40 generates a decision list based on the learned stochastic decision list. Specifically, based on the learned stochastic decision list, the discretization unit 40 selects the rule with the highest corresponding the degree of occurrence among the same rules to generate the decision list. In terms of the above group, the discretization unit 40 generates a discrete decision list by replacing the degree of occurrence of the rule with the highest corresponding degree of occurrence in the same group with 1 and replacing the degree of occurrence of the rules other than the replaced rule with 0. This means that the list of rules are considered to be stochastically distributed to be a discrete list of rules by applying only those rules whose degrees of occurrence have been replaced by 1.

Thus, the discretization unit 40 can be said to be a decision list generator, as it generates a discrete decision list from a stochastic decision list that shows a stochastic distribution. It can also be said that the discretization unit 40 is in the process of fixing the rule at the position of maximum probability.

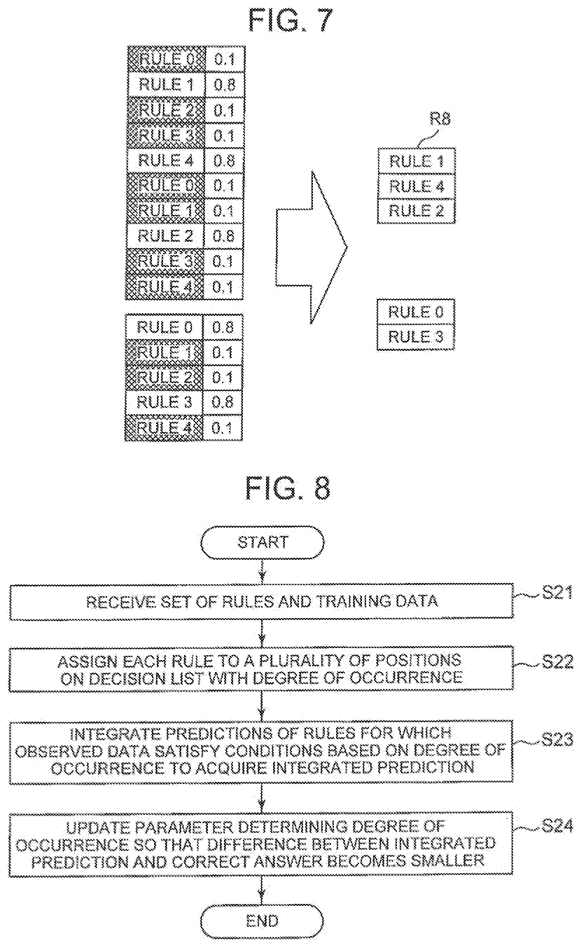

FIG. 7 is an explanatory diagram of an example of the process of generating a decision list. For example, suppose that the result illustrated in FIG. 6 is obtained as a stochastic decision list. Here, when rule 1 is focused on, it is acknowledged that the position with the highest degree of occurrence is the second line with a degree of occurrence of 0.8. Therefore, the discretization unit 40 decides that for rule 1, the rule assigned to the second line is applied. Similarly, for rule 2, the rule assigned to line 8 has a higher degree of occurrence than the rule assigned to line 3. Therefore, the discretization unit 40 decides that for rule 2, the rule assigned to line 8 is applicable. The same is true for the other rules.

As a result of the above process for all groups (rules), the discretization unit 40 generates the decision list R8 in the order of rule 1, rule 4, and rule 2. In addition, since rules 0 and 3 in the out-list rule set are unnecessary, the discretization unit 40 excludes the rules 0 and 3 from the decision list.

The output unit 50 outputs the generated decision list.

The input unit 10, the stochastic decision list generator 20, the stochastic decision list learning unit 30, the discretization unit 40, and the output unit 50 are realized by a computer processor (for example, a CPU (Central Processing Unit), a GPU (Graphics Processing Unit), FPGA (field-programmable gate array) that operates according to a program (decision list learning program).

For example, the program may be stored in a storage unit (not shown) provided by the decision list learning device 100, and the processor may read the program and operate as the input unit 10, the stochastic decision list generator 20, the stochastic decision list learning unit 30, the discretization unit 40, and the output unit 50, according to the program. In addition, the function of the decision list learning device 100 may be provided in SaaS (Software as a Service) format.

The input unit 10, the stochastic decision list generator 20, the stochastic decision list learning unit 30, the discretization unit 40, and the output unit 50 may each be realized by dedicated hardware. In addition, some or all of each component of each device may be realized by general-purpose or dedicated circuits (circuitry), processors, etc. or a combination of these. They may be configured by a single chip or by multiple chips connected via a bus. Some or all of each component of each device may be realized by a combination of the above-mentioned circuitry, etc. and programs.

In the case where some or all of the components of the decision list learning device 100 are realized by a plurality of information processing devices, circuits, or the like, the plurality of information processing devices, circuits, or the like may be centrally located or distributed. For example, the information processing devices, circuits, etc. may be realized as a client-server system, a cloud computing system, etc., each of which is connected through a communication network.

Next, the operation of the decision list learning device 100 of this example embodiment will be described. FIG. 8 is a flowchart showing an example of operation of the decision list learning device 100 of this example embodiment. The input unit 10 receives a set of rules (rule set) including conditions and predictions, and training data which is a pair of observed data and correct answers (step S21). The stochastic decision list generator 20 assigns each rule in the set of rules to a plurality of positions on the decision list with a degree of occurrence indicating an occurrence degree (step S22). The stochastic decision list learning unit 30 integrates the predictions of the rules for which the observed data satisfies the condition based on the degree of occurrence to acquire an integrated prediction (step S23), and updates the parameter determining the degree of occurrence so that the difference between the integrated prediction and the correct answer becomes small (step S24).

Thereafter, the discretization unit 40 generates a discrete decision list from a stochastic decision list with rules and degrees of occurrence assigned to multiple positions, and the output unit 50 outputs the generated decision list.

As described above, in this example embodiment, the input unit 10 receives a set of rules and training data, and the stochastic decision list generator 20 assigns each rule in the set of rules to a plurality of positions on the decision list with degrees of occurrence. Then, the stochastic decision list training unit 30 updates the parameter determining the degree of occurrence so that the difference between the integrated prediction acquired by integrating, based on the degree of occurrence, the predictions of the rules whose conditions are satisfied by the observed data, and the correct answer becomes small. Thus, the decision list can be constructed in a practical time while increasing the accuracy of the prediction.

That is, a genera decision list is discrete and not differentiable, whereas the stochastic decision list is continuous and differentiable. In this example embodiment, the stochastic decision list generator 20 generates a stochastic decision list by assigning each rule to a plurality of positions on the decision list with a degree of occurrence. The generated decision list is a stochastic decision list by considering the rules to be stochastically distributed and can be optimized by the gradient descent method, thus allowing a more accurate decision list to be constructed in a practical time.

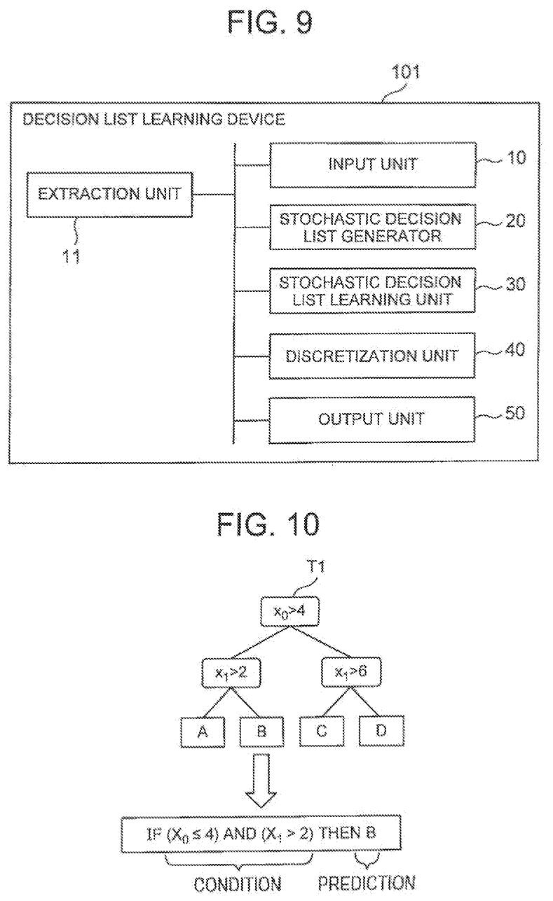

Next, a modified example of the first example embodiment will be described. FIG. 9 is a block diagram showing a modified example of the decision list learning device of the first example embodiment. The decision list learning device 101 of this modified example is provided with an extraction unit 11 in addition to the decision list learning device 100 of the first example embodiment.

The input unit 10 receives input of a decision tree instead of a rule set. The extraction unit 11 extracts rules from the received decision tree. Specifically, the extractor 11 extracts from the decision tree, as a plurality of rules, a condition for tracing a leaf node from a root node and a prediction indicated by that leaf node.

FIG. 10 is an explanatory diagram of an example of the process of extracting a rule. Suppose that the input unit 10 receives the decision tree T1 illustrated in FIG. 10. The extraction unit 11 traces the leaf nodes from the root node to the leaf node to extract the rule that combines the conditions set for each node and the prediction indicated by that leaf node. For example, the extractor 11 extracts “(x₀≤4) AND (x₁>2)” as a condition to a leaf node whose prediction is “B”. The extractor 11 should extract the conditions and predictions for other leaf nodes as well.

In this way, the extraction unit 11 extracts multiple rules from the decision tree, making it possible to process in conjunction with a decision tree ensemble such as Random Forest.

### Example Embodiment 2

Next, a second example embodiment of a decision list learning device according to the present invention will be described. The first example embodiment describes how the stochastic decision list generator 20 generates a list with one rule assigned to one position (a stochastic decision list). This example embodiment describes how to learn a decision list using a list with multiple rules assigned to a single position.

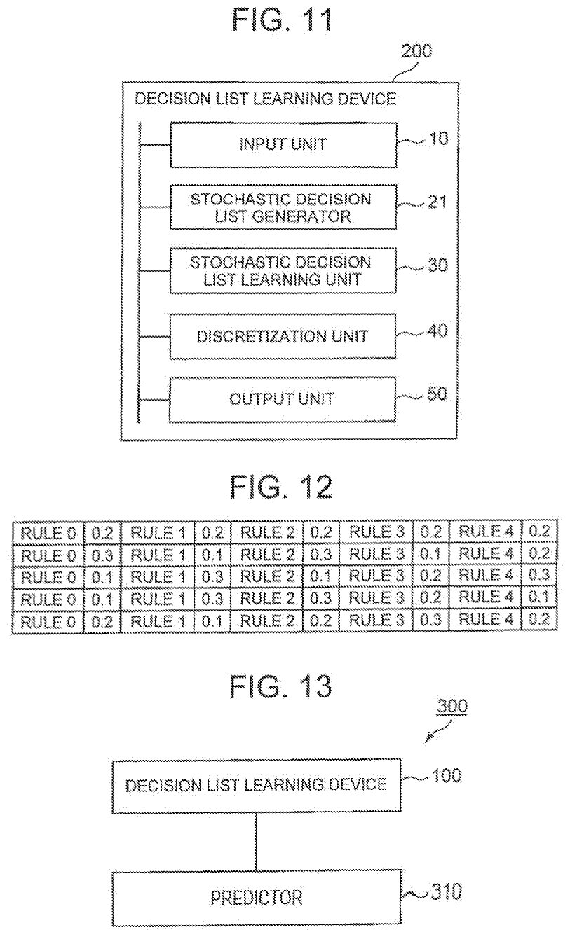

FIG. 11 is a block diagram showing an example configuration of a second example embodiment of a decision list learning device according to the present invention. The decision list learning device 200 in this example embodiment has an input unit 10, a stochastic decision list generator 21, a stochastic decision list learning unit 30, a discretization unit 40, and an output unit 50.

That is, the decision list learning device 200 of this example embodiment differs from the decision list learning device 100 of the first example embodiment in that it has a stochastic decision list generator 21 instead of a stochastic decision list generator 20. Otherwise, the configuration is the same as in the first example embodiment. The decision list learning device 200 may be provided with an extraction unit 11 shown in a modified example of the first example embodiment.

The stochastic decision list generator 21 generates a list in which rules and degrees of occurrence are associated, similar to the stochastic decision list generator 20 of the first example embodiment. However, the stochastic decision list generator 21 of this example embodiment generates a stochastic decision list in which a plurality of rules and degrees of occurrence are assigned to a single position. In the case of that, the stochastic decision list generator 21 normalizes the probabilities of the rules existing in one position to a total of 1.

In this example embodiment, a plurality of rules existing in a single position are treated as a single group. Therefore, it can be said that the stochastic decision list generator 21 of this example embodiment also determines the degrees of occurrence so that a sum of the degrees of occurrence of the rules belonging to the same group is 1. In other words, the stochastic decision list generator 21 determines the degrees of occurrence so that the sum of the degrees of of occurrence of multiple rules assigned to the same position is 1.

FIG. 12 is an explanatory diagram showing an example of a stochastic decision list. The example shown in FIG. 12 shows a stochastic decision list with five rules (rules 0-4) and degrees of occurrence assigned to a single position. The example shown in FIG. 12 also shows that each line corresponds to one group and has a sum of degrees of occurrence is 1.0.

The stochastic decision list learning unit 30 of this example embodiment also integrates predictions of rules for which the observed data contained in the received training data satisfies a condition, based on the degree of occurrence corresponding to the rule. Specifically, the stochastic decision list learning unit 30 calculates the weights of the rules so that the greater the degree of occurrence of a rule whose condition is satisfied by the observed data, the less a weight of a following rule.

In this example embodiment, the stochastic decision list learning unit 30 calculates the weights of the rules by taking the sum of the degrees of occurrence of the rules corresponding to the input data x at one position as probability q and multiplying the cumulative product of (1−q) by the degrees of occurrence of the subsequent rules. The weighted linear combination which is calculated by multiplying the above calculated weights by each prediction and adding multiplied values may be used as an integrated prediction.

For example, suppose that in the situation where the stochastic decision list illustrated in FIG. 12 is generated, observed data satisfying the conditions of rule 1 and rule 3 are received.

In this case, the stochastic decision list training unit 30 extracts the rules 1 and 3 that include conditions satisfied by the received observed data.

Next, the stochastic decision list learning unit 30 calculates a sum of the degrees of occurrence of the corresponding rules at each position, and regards the sum as the probability q. The stochastic decision list learning unit 30 calculates the weights by multiplying the probability p of each rule by the value of the probability q of its previous rule, subtracted from 1 (i.e., 1−q).

In the example shown in FIG. 12, the sum of the probabilities of rule 1 and rule 3 at the first line is 0.2+0.2=0.4. Therefore, the stochastic decision list learning unit 30 calculates the weight (i.e., 0.06) by multiplying the probability 0.1 of rule 1 at the second line by the sum of the probabilities of the rules at the first line, subtracted from 1 (i.e., 1−0.4). Similarly, the stochastic decision list learning unit 30 calculates the weight (i.e., 0.06) by multiplying the probability 0.1 of rule 3 at the second line by the sum of the probabilities of the rules at the first line, subtracted from 1 (i.e., 1−0.4). The same is true for the following lines.

The stochastic decision list learning unit 30 then calculates the weighted linear combination of the calculated weights as coefficients for each prediction as the predicted value.

Thereafter, as in the first example embodiment, the stochastic decision list learning unit 30 will update the parameters determining the degree of occurrence so that the difference between the integrated prediction and the correct answer becomes small. In this example embodiment, for example, in the limit of τ to 0 in the above Equation 2, as in the first example embodiment, the stochastic decision list will converge to a genera decision list.

As described above, in this example embodiment, the stochastic decision list generator 21 generates a stochastic decision in which multiple rules and degrees of occurrence are assigned to a single position, and the stochastic decision list learning unit 30 updates the parameters for determining degrees of occurrence so that the difference between the integrated prediction and the correct answer becomes small. Such a configuration also allows for the construction of a decision list in a practical time while increasing prediction accuracy.

### Example Embodiment 3

Next, an example application of the decision list generated by the present invention is described. In general, in the decision list, the conditions for input x are checked from top to bottom and the first applicable rule is selected. This example embodiment explains how to extend the rules to be selected, and even if a corresponding rule is found, select further corresponding rules in subsequent conditions for processing.

FIG. 13 is a block diagram showing an example configuration of the information processing system 300 of the present invention. The information processing system 300 illustrated in FIG. 13 is provided with a decision list learning device 100 and a predictor 310. Instead of the decision list learning device 100, the decision list learning device 101 or the decision list learning device 200 may be used. Also, the predictor 310 may be integrated with the decision list learning device 100.

The predictor 310 acquires the decision list learned by the decision list learning device 100. Then, the predictor 310 checks the decision list from the top to the bottom until the predetermined number of conditions are satisfied, and acquires from the decision list the predetermined number of rules including conditions corresponding to input x. If predetermined number of conditions do not exist, the predictor 310 may acquire all rules corresponding to the conditions from the decision list.

The predictor 310 then makes a prediction using all of the acquired rules. The predictor 310 may, for example, determine an average of the predictions of the acquired rules as the final prediction. If a weight is set for each rule in the decision list, the predictor 310 may calculate the prediction according to the weight of each rule.

The method of retrieving one rule from the decision list that corresponds to a condition and making a prediction based on that rule is consistent with the general method using a decision list. In this case, it is possible to make predictions with high interpretability. On the other hand, the method of making prediction in a majority decision manner, using the predictions of multiple rules, can improve the accuracy of the predictions.

That is, when the number of rules to be selected from the decision list is set to k, then k=1 is consistent with the general method of using the decision list. In addition, in the case of k=∞, it is consistent with the method using the Random Forest, because the process takes into account multiple rules. Thus, the process of selecting k rules from the top can be called top-k decision lists.

Further, the value of k (i.e., the number of rules to be selected) can be pre-specified by the user. As mentioned above, in the case of k=1, more interpretable predictions can be made, and the accuracy of the predictions can be improved as k is increased. That is, the user can freely choose the trade-off between interpretability and prediction accuracy.

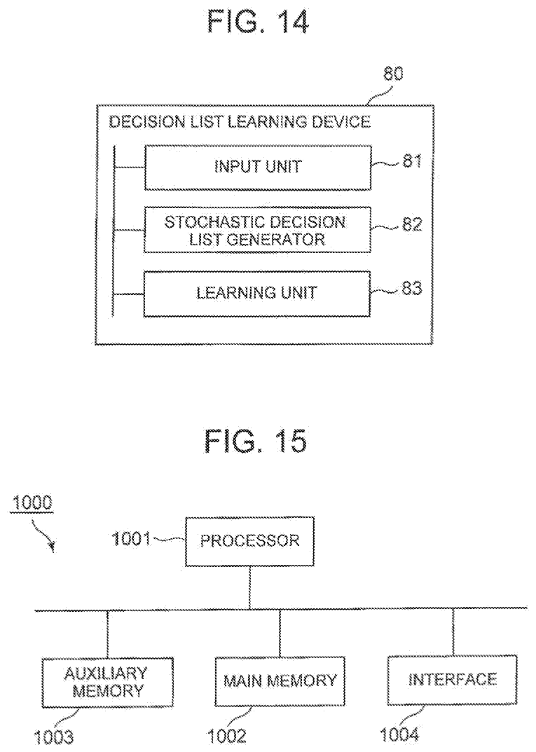

Next, an overview of the present invention will be described. FIG. 14 is a block diagram showing a summarized decision list learning device according to the present invention. The decision list learning device 80 according to the present invention is a decision list learning device (for example, decision list learning device 100, 101, 201), and includes an input unit 81 (for example, input unit 10) which receives a set of rules each including a condition and a prediction, and pairs (for example, training data) of observed data and correct answers, a stochastic decision list generator (for example, stochastic decision list generator 20) which assigns each rule in the set of rules to a plurality of positions in the decision list with a degree of occurrence indicating occurrence degree (for example, generates a stochastic decision list), and a learning unit 83 (for example, a stochastic decision list learning unit 30) which updates a parameter determining the degree of occurrence so that a difference between an integrated prediction (for example, a weighted linear combination) acquired by integrating, based on the degree of occurrence, the predictions of the rules whose conditions are satisfied by the observed data and the correct answer becomes small.

According to such a configuration, a decision list can be made in a practical time while increasing prediction accuracy.

The learning unit 83 may calculate a weight of the rule so that the greater the degree of occurrence of the rule whose condition is satisfied by the observed data, the less a weight of a rule that follows the rule, and integrates the predictions of the rules using the weights as an integrated prediction. In this way, by calculating the weight of a rule so that the greater the degree of occurrence of the rule whose condition is satisfied by the observed data, the less a weight of a rule that follows the rule, an effect that following rules that exist after the rule do not have to be used is obtained.

The stochastic decision list generator 82 may also determine the degree of occurrence so that a sum of the degrees of occurrences of rules belonging to the same group is 1.

Specifically, the stochastic decision list generator 82 may group the same rules assigned to multiple positions and determines so that a sum of the degrees of occurrence of rules belonging to each group is 1.

Alternatively, the stochastic decision list generator 82 may group a plurality of rules assigned to the same position and determines the degree of occurrence so that a sum of the degrees of occurrence of rules belonging to each group is 1.

The decision list learning device 80 may also include a discretization unit (for example, discretization unit 40) which generates a discrete list as the decision list by replacing the highest degree of occurrence in the same group with 1 and replacing other degrees of occurrence that are not replaced with 0.

The decision list learning device 80 may also include an extraction unit (for example, extraction unit 11) that extracts rules from the decision tree. The input portion 81 may receive the decision tree, and the extraction unit may extract from the received decision tree the condition for tracing a leaf node from a root node and the prediction indicated by the leaf node as the rule. Such a configuration makes it possible to extract a plurality of rules from the decision tree.

The stochastic decision list generator 82 may assign respective rules to multiple positions in the decision list, with the degrees of occurrence, by duplicating all the rules in the set of rules multiple times and concatenating duplicates. According to such a configuration, the parameters can be defined in a matrix, allowing a gradient to be calculated by matrix operations.

The learning unit 83 may also regard a weighted linear combination, which is generated by multiplying the predictions of the rules by the weights of the rules reduced according to the degrees of occurrence respectively and adding all results of multiplication, as the integrated prediction.

FIG. 15 is a summarized block diagram showing a configuration of a computer for at least one example embodiment. The computer 1000 has a processor 1001, a main memory 1002, an auxiliary memory 1003, and an interface 1004.

The above-mentioned decision list learning device 80 is implemented in a computer 1000. The operation of each of the above-described processing units is stored in the auxiliary memory 1003 in the form of a program (decision list learning program). The processor 1001 reads the program from the auxiliary memory 1003 and develops the program to the main memory 1002, and executes the above process in accordance with the program.

In at least one example embodiment, the auxiliary memory 1003 is an example of a non-transitory tangible medium. Other examples of non-transitory tangible media are a magnetic disk, a an optical magnetic disk, a CD-ROM (Compact Disc Read-only memory), a DVD-ROM (Read-(only memory), a semiconductor memory, etc. When the program is delivered to the computer 1000 through a communication line, the computer 1000 receiving the delivery may develop the program to the main memory 1002 and perform the above processes.

The program may also be one for realizing some of the aforementioned functions. Furthermore, the program may be a so-called differential file (differential program), which realizes the aforementioned functions in combination with other programs already stored in the auxiliary memory 1003.

The aforementioned exemplary embodiments can be described as supplementary notes mentioned below, but are not limited to the following supplementary notes.

(Supplementary note 1) A decision list learning device for learning a decision list, comprising:

an input unit which receives a set of rules each including a condition and a prediction, and pairs of observed data and correct answers;

a stochastic decision list generator which assigns each rule in the set of rules to a plurality of positions in the decision list with a degree of occurrence indicating occurrence degree; and

a learning unit which updates a parameter determining the degree of occurrence so that a difference between an integrated prediction acquired by integrating, based on the degree of occurrence, the predictions of the rules whose conditions are satisfied by the observed data and the correct answer becomes small.

(Supplementary note 2) The decision list learning device as described in Supplementary note 1, wherein the learning unit calculates a weight of the rule so that the greater the degree of occurrence of the rule whose condition is satisfied by the observed data, the less a weight of a rule that follows the rule, and integrates the predictions of the rules using the weights as the integrated prediction.

(Supplementary note 3) The decision list learning device as described in Supplementary note 1 or 2, wherein the stochastic decision list generator determines the degree of occurrence so that a sum of the degrees of occurrences of rules belonging to the same group is 1.

(Supplementary note 4) The decision list learning device as described in any one of Supplementary notes 1 to 3, wherein the stochastic decision list generator groups the same rules assigned to multiple positions and determines so that a sum of the degrees of occurrence of rules belonging to each group is 1.

(Supplementary note 5) The decision list learning device as described in any one of Supplementary notes 1 to 3, wherein the stochastic decision list generator groups a plurality of rules assigned to the same position and determines the degree of occurrence so that a sum of the degrees of occurrence of rules belonging to each group is 1.

(Supplementary note 6) The decision list learning device as described in any one of Supplementary notes 3 to 5, further comprising: a discretization unit which generates a discrete list as the decision list by replacing the highest degree of occurrence in the same group with 1 and replacing other degrees of occurrence that are not replaced with 0.

(Supplementary note 7) The decision list learning device as described in any one of Supplementary notes 1 to 6, wherein the input unit receives the decision tree, and the extraction unit extracts from the received decision tree the condition for tracing a leaf node from a root node and the prediction indicated by the leaf node as the rule.

(Supplementary note 8) The decision list learning device as described in any one of Supplementary notes 1 to 7, wherein the stochastic decision list generator assigns respective rules to multiple positions in the decision list, with the degrees of occurrence, by duplicating all the rules in the set of rules multiple times and concatenating duplicates.

(Supplementary note 9) The decision list learning device as described in Supplementary note 2, wherein the learning unit regards a weighted linear combination, which is generated by multiplying the predictions of the rules by the weights of the rules reduced according to the degrees of occurrence respectively and adding all results of multiplication, as the integrated prediction.

(Supplementary note 10) A decision list learning method for learning a decision list, comprising:

receiving a set of rules each including a condition and a prediction, and pairs of observed data and correct answers;

assigning each rule in the set of rules to a plurality of positions in the decision list with a degree of occurrence indicating occurrence degree; and

updating a parameter determining the degree of occurrence so that a difference between an integrated prediction acquired by integrating, based on the degree of occurrence, the predictions of the rules whose conditions are satisfied by the observed data and the correct answer becomes small.

(Supplementary note 11) The decision list learning method as described in Supplementary note 10, wherein a weight of the rule so that the greater the degree of occurrence of the rule whose condition is satisfied by the observed data, the less a weight of a rule that follows the rule is calculated, and the predictions of the rules are integrated using the weights as the integrated prediction.

(Supplementary note 12) A decision list learning program applied to a computer to learn a decision list, causing the computer to execute:

an inputting process of receiving a set of rules each including a condition and a prediction, and pairs of observed data and correct answers;

a stochastic decision list generating process of assigning each rule in the set of rules to a plurality of positions in the decision list with a degree of occurrence indicating occurrence degree; and

a learning process of updating a parameter determining the degree of occurrence so that a difference between an integrated prediction acquired by integrating, based on the degree of occurrence, the predictions of the rules whose conditions are satisfied by the observed data and the correct answer becomes small.

(Supplementary note 13) The decision list learning program as described in Supplementary note 12, causing the computer to execute:

in the learning process, calculating a weight of the rule so that the greater the degree of occurrence of the rule whose condition is satisfied by the observed data, the less a weight of a rule that follows the rule, and integrating the predictions of the rules using the weights as the integrated prediction.

### REFERENCE SIGNS LIST

10 input unit
11 extraction unit
20, 21 stochastic decision list generator
30 stochastic decision list learning unit
40 discretization unit
50 output unit
100, 101, 200 decision list learning device
300 information processing system
310 predictor

What is claimed is:

1. A decision list learning device for learning a decision list, comprising a hardware processor configured to execute a software code to:
receive a set of rules each including a condition and a prediction, and pairs of observed data and correct answers;
assign each rule in the set of rules to a plurality of positions in the decision list with a degree of occurrence indicating occurrence degree; and
update a parameter determining the degree of occurrence so that a difference between an integrated prediction acquired by integrating, based on the degree of occurrence, the predictions of the rules whose conditions are satisfied by the observed data and the correct answer becomes small.

2. The decision list learning device according to claim 1, wherein the hardware processor is configured to execute a software code to
calculate a weight of the rule so that the greater the degree of occurrence of the rule whose condition is satisfied by the observed data, the less a weight of a rule that follows the rule, and integrate the predictions of the rules using the weights as the integrated prediction.

3. The decision list learning device according to claim 1, wherein the hardware processor is configured to execute a software code to
determine the degree of occurrence so that a sum of the degrees of occurrences of rules belonging to the same group is 1.

4. The decision list learning device according to claim 1, wherein the hardware processor is configured to execute a software code to
group the same rules assigned to multiple positions and determine so that a sum of the degrees of occurrence of rules belonging to each group is 1.

5. The decision list learning device according to claim 1, wherein the hardware processor is configured to execute a software code to
group a plurality of rules assigned to the same position and determine the degree of occurrence so that a sum of the degrees of occurrence of rules belonging to each group is 1.

6. The decision list learning device according to claim 1, wherein the hardware processor is configured to execute a software code to
generate a discrete list as the decision list by replacing the highest degree of occurrence in the same group with 1 and replacing other degrees of occurrence that are not replaced with 0.

7. The decision list learning device according to claim 1, wherein the hardware processor is configured to execute a software code to:
receive a decision tree; and
extract from the received decision tree the condition for tracing a leaf node from a root node and the prediction indicated by the leaf node as the rule.

8. The decision list learning device according to claim 1, wherein the hardware processor is configured to execute a software code to
assign respective rules to multiple positions in the decision list, with the degrees of occurrence, by duplicating all the rules in the set of rules multiple times and concatenating duplicates.

9. The decision list learning device according to claim 2, wherein the hardware processor is configured to execute a software code to
regard a weighted linear combination, which is generated by multiplying the predictions of the rules by the weights of the rules reduced according to the degrees of occurrence respectively and adding all results of multiplication, as the integrated prediction.

10. A decision list learning method for learning a decision list, comprising:
receiving a set of rules each including a condition and a prediction, and pairs of observed data and correct answers;
assigning each rule in the set of rules to a plurality of positions in the decision list with a degree of occurrence indicating occurrence degree; and
updating a parameter determining the degree of occurrence so that a difference between an integrated prediction acquired by integrating, based on the degree of occurrence, the predictions of the rules whose conditions are satisfied by the observed data and the correct answer becomes small.

11. The decision list learning method according to claim 10, wherein
a weight of the rule so that the greater the degree of occurrence of the rule whose condition is satisfied by the observed data, the less a weight of a rule that follows the rule is calculated, and the predictions of the rules are integrated using the weights as the integrated prediction.

12. A non-transitory computer readable information recording medium storing a decision list learning program applied to a computer to learn a decision list, when executed by a processor, the program performs a method for:
receiving a set of rules each including a condition and a prediction, and pairs of observed data and correct answers;
assigning each rule in the set of rules to a plurality of positions in the decision list with a degree of occurrence indicating occurrence degree; and
updating a parameter determining the degree of occurrence so that a difference between an integrated prediction acquired by integrating, based on the degree of occurrence, the predictions of the rules whose conditions are satisfied by the observed data and the correct answer becomes small.

13. The non-transitory computer readable information recording medium according to claim 12,
wherein a weight of the rule so that the greater the degree of occurrence of the rule whose condition is satisfied by the observed data, the less a weight of a rule that follows the rule is calculated, and the predictions of the rules are integrated using the weights as the integrated prediction.
